(19) United States
(12) Patent Application Publication
(10) Pub. No.: US 2019/0383723 A1
(43) Pub. Date: Dec. 19, 2019

(54) Systems and Methods of Electro-optic Applications with Metal Nanoparticles in Dielectric Media

(71) Applicant: Mrinal Thakur, Auburn, AL (US)

(72) Inventor: Mrinal Thakur, Auburn, AL (US)

(21) Appl. No.: 16/012,429

(22) Filed: Jun. 19, 2018

(51) Int. Cl. G01N 15/14; H01S 3/22

(52) U.S. Cl. CPC G01N 15/1434; G01N 2015/0038; H01S 3/2222

(57) ABSTRACT

The quadratic electro-optic effect (Kerr coefficients) is measured for metal nanoparticles within a transparent dielectric medium. In particular, gold nanoparticles in glass are studied. Measurements are made using a field-induced birefringence method. The magnitudes of the Kerr coefficients for different sizes of gold nanoparticles in glass are measured. The magnitudes significantly increase for smaller sizes of nanoparticles. These results imply a broad range of applications of metal nanoparticles in dielectric media, such as glass, in ultrafast (up to 100 GHZ or more) electro-optic modulation/switching, low-cost Kerr cells and other uses in optoelectronics. These results may be extended to various metal nanoparticles within various other transparent dielectric media such as polymers/plastics and ceramics, as well as in glass.

### TECHNICAL FIELD

The present disclosure is generally related to material science and, more particularly, is related to metal nanoparticles.

### BACKGROUND

Nanoparticles are particles between 1 and 100 nanometers (nm) in size. Particles are further classified according to diameter. Nanoparticles are of great scientific interest as they are, in effect, a bridge between bulk materials and atomic or molecular structures. A bulk material should have constant physical properties regardless of its size, but at the nano-scale size-dependent properties are often observed. Thus, the properties of materials change as their size approaches the nanoscale and as the percentage of the surface in relation to the percentage of the volume of a material becomes significant. For bulk materials larger than one micrometer (or micron), the percentage of the surface is insignificant in relation to the volume in the bulk of the material. The interesting and sometimes unexpected properties of nanoparticles are therefore largely due to the large surface area of the material, which dominates the contributions made by the small bulk of the material.

Nanoparticles often possess unexpected optical properties as they are small enough to confine their electrons and produce quantum effects. For example, gold nanoparticles appear deeply colored in solution. Nanoparticles of yellow gold and grey silicon are red in color. Gold nanoparticles melt at much lower temperatures (˜300° C. for 2.5 nm size) than the gold slabs (1064° C.). Absorption of solar radiation is much higher in materials composed of nanoparticles than it is in thin films of continuous sheets of material. In both solar PV and solar thermal applications, controlling the size, shape, and material of the particles, it is possible to control solar absorption. Suspensions of nanoparticles are possible since the interaction of the particle surface with the solvent is strong enough to overcome density differences, which otherwise usually result in a material either sinking or floating in a liquid.

Metal, dielectric, and semiconductor nanoparticles have been formed, as well as hybrid structures (e.g., core-shell nanoparticles). Nanoparticles may be labeled quantum dots if they are smaller than about 10 nm. Noble metal nanoparticles in general and their gold and silver analogs in particular are attracting huge interest from the scientific community owing to their fabulous properties and diversity of applications. Nanoscale analogs are being explored due to their unusual functional attributes quite unlike the bulk. Tunability of properties by varying size, shape, composition, or local environment presents them with unusual capabilities. By manipulating the chemical composition of the materials at the nanoscale, their electrical, chemical, optical, and other properties can be manipulated precisely. There are heretofore unaddressed needs with determining quadratic electro-optic effects for selecting appropriate nanoparticle/materials.

### SUMMARY

Example embodiments of the present disclosure provide systems of electro-optic applications with metal nanoparticles in dielectric media. Briefly described, in architecture, one example embodiment of the system, among others, can be implemented as follows: electrodes connected to the dielectric material containing nanoparticles; an alternating current (AC) generator configured to apply an AC field to the dielectric material through the electrodes; a laser configured to project a laser beam through the dielectric material; and a measurement system to record the modulation of the intensity of light that has passed through the dielectric material.

Embodiments of the present disclosure can also be viewed as providing methods for electro-optic applications with metal nanoparticles in dielectric media. In this regard, one embodiment of such a method, among others, can be broadly summarized by the following steps: applying an alternating current (AC) field to a sample comprising nanoparticles; determining Kerr coefficients of the sample; and selecting the sample for electro-optic use based on the determined Kerr coefficients.

### BRIEF DESCRIPTION OF THE DRAWINGS

FIG. 1 is a system block diagram of an example embodiment of a system of electro-optic applications with metal nanoparticles in dielectric media.

FIG. 2 is an example embodiment of a graph of optical absorption spectrum of a selected nanoparticle in a selected dielectric medium, such as gold nanoparticles in glass.

FIG. 3 is an example embodiment of a graph of quadratic electro-optic modulation data for various applied electric fields for a selected nanoparticle in a selected dielectric medium such as gold nanoparticles in glass.

FIG. 4 is a flow diagram of an example embodiment of a method of electro-optic applications with metal nanoparticles in dielectric media.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

The quadratic electro-optic effect (Kerr coefficients) is measured for metal nanoparticles within a transparent dielectric medium. In particular, gold nanoparticles in glass are studied. The measurements are made using a field-induced birefringence method. The magnitudes of the Kerr coefficients for different sizes of gold nanoparticles in glass are measured. The magnitudes significantly increase for smaller sizes of nanoparticles. These results imply a broad range of applications of metal nanoparticles in dielectric media, such as glass, in ultrafast electro-optic modulation/switching, low-cost Kerr cells and other uses in optoelectronics. These results may be extended to various metal nanoparticles within various other transparent dielectric media such as polymers/plastics and ceramics, as well as in glass.

The Kerr effect, also called the quadratic electro-optic (QEO) effect, is a change in the refractive index of a material in response to an applied electric field. The Kerr effect is distinct from the Pockels effect in that the induced index change is directly proportional to the square of the electric field instead of varying linearly with it. All materials show a Kerr effect, but certain liquids display it more strongly than others. The Kerr effect was discovered in 1875 by John Kerr, a Scottish physicist.

Nonlinear optics in metal nanoparticles within transparent dielectric media has been studied extensively. In particular, third order optics using ultrashort (femtosecond) laser pulses in such metal nanoparticle systems have been widely studied and reported. These metallic nanoparticles are also called quantum dots since many of their properties can be understood considering the quantum confinement of the electrons within nanometer dimensions. The third-order susceptibilities (χ⁽³⁾) and response-times of various nanometals in dielectric media have been measured for different nano-particle-radii. However, as our literature review has revealed, no measurement of the quadratic electro-optic effect in such systems has been published or known in the prior art and third order susceptibility as a function of particle-size has not been conclusively established. Quadratic electro-optic effect has applications in ultrafast electro-optic modulation/switching and also as, Kerr cells, Kerr-gates for mode-locking, Q-switching and other applications in lasers.

Example embodiments of systems and methods of electro-optic applications with metal nanoparticles in dielectric media disclosed herein determine the quadratic electro-optic/Kerr effect and formulate related applications of metal nanoparticles in transparent dielectric media such as glass. The quadratic electro-optic effect is given by: Δn=KλE², where Δn is the change in refractive index, K is Kerr coefficient, A is wavelength of light and E is the applied electric field. A change in refractive index occurs when an electric field is applied. This change in refractive index leads to electro-optic switching/modulation and may be taken advantage of in related device applications. The larger the Kerr coefficient, the larger is the change in refractive index for any given electric field.

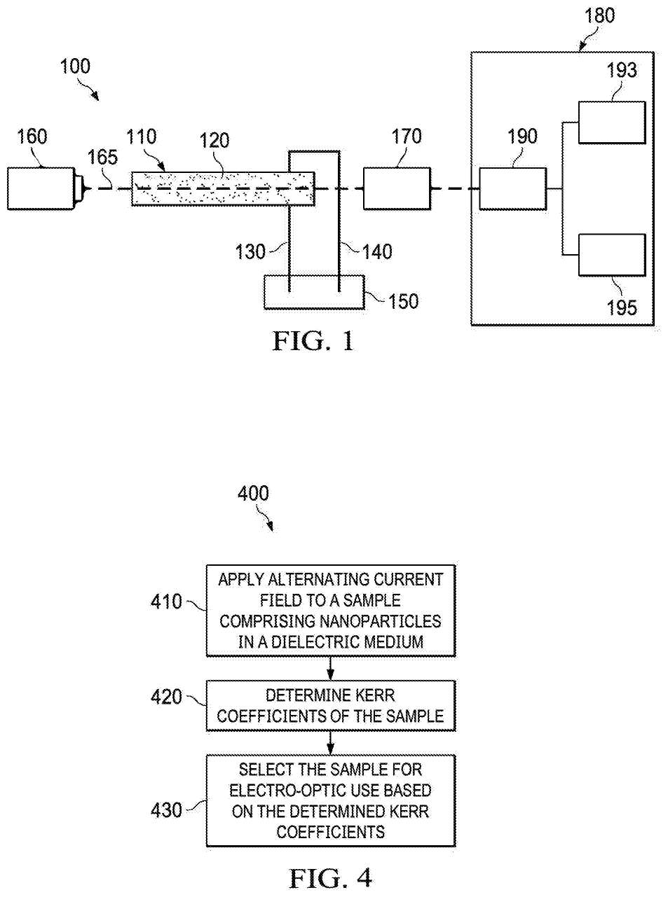

As disclosed herein, measurements of the quadratic electro-optic/Kerr effect in metal nanoparticles within glass have been made on metal nanoparticles of different sizes and larger effects for smaller particle sizes have been observed. Kerr coefficients at specific wavelengths have been determined. The characteristics as measured are important for applications in electro-optic modulation/switching, Kerr-cells and other relevant applications. As provided in the example embodiment of FIG. 1, sample 100 of glass containing gold nanoparticles 110 are characterized using optical absorption spectroscopy, and the positions of the surface-plasmon-resonances are determined. The particle sizes are estimated from the surface-plasmon-resonances (peak position and relative intensity of the peak). Glass samples 100 are used for measurement of the quadratic electro-optic/Kerr coefficients at a specific wavelength.

In an example embodiment, metal electrodes 130, 140 are applied on gold nanoparticles-in-glass samples 100. AC generator 150 is used to apply an alternating current field to electrodes 130, 140. Quadratic electro-optic measurements are made using field-induced birefringence. Briefly, the measurements are made as follows. He:Ne laser 160 (wavelength 633 nm) is used in these measurements to determine the Kerr coefficients. Laser beam 165 is polarized at 45° with respect to the applied electric field and passed through sample 100. The transmitted beam is passed through analyzer 170 which is cross-polarized with respect to the polarizer and the final optical modulation is detected by measurement system 180, including a photo-detector (photodiode), a lock-in amplifier, and an oscilloscope. The modulation signal is recorded for various applied AC electric fields and is found to depend quadratically on the applied voltage. The Kerr coefficients are determined from the observed modulations, applied fields, and interaction path-lengths within the samples for given wavelengths. Besides the field-induced birefringence method discussed above, other methods involving optical interference (for example, Michelson, Mach-Zehnder, and Fabry-Perot) may be used to determine the Kerr coefficients. The AC field may involve high frequencies up to about 100 GHz or more (radio frequency (RF)) for these applications.

Significant electro-optic modulations/Kerr coefficients areobserved in the nanometal-containing glasses. Under the same experimental conditions, no detectable modulation is observed for glasses without metal nanoparticles. The Kerr coefficient increases significantly as particle size is decreased. These metal nanoparticles within glass materials have various applications in ultrafast electro-optic switching/modulation, Kerr cells, and other devices. Although the present results are for metal nanoparticles in glass, the results may be extended to metal nanoparticles in other transparent dielectric (nonconductive) media.

Example embodiments of the systems and methods of electro-optic applications with metal nanoparticles in dielectric media disclosed herein include novel electro-optic materials, in particular, quadratic electro-optic materials, which are optically uniform and contain metal nanoparticles within transparent dielectric materials such as glass. Significant quadratic electro-optic coefficients/Kerr coefficients (>10⁻¹⁴ m/V²) have been measured for different sizes of metal nanoparticles. These results imply a broad range of applications in ultrafast electro-optic switching/modulation, Kerr cells, and other relevant devices.

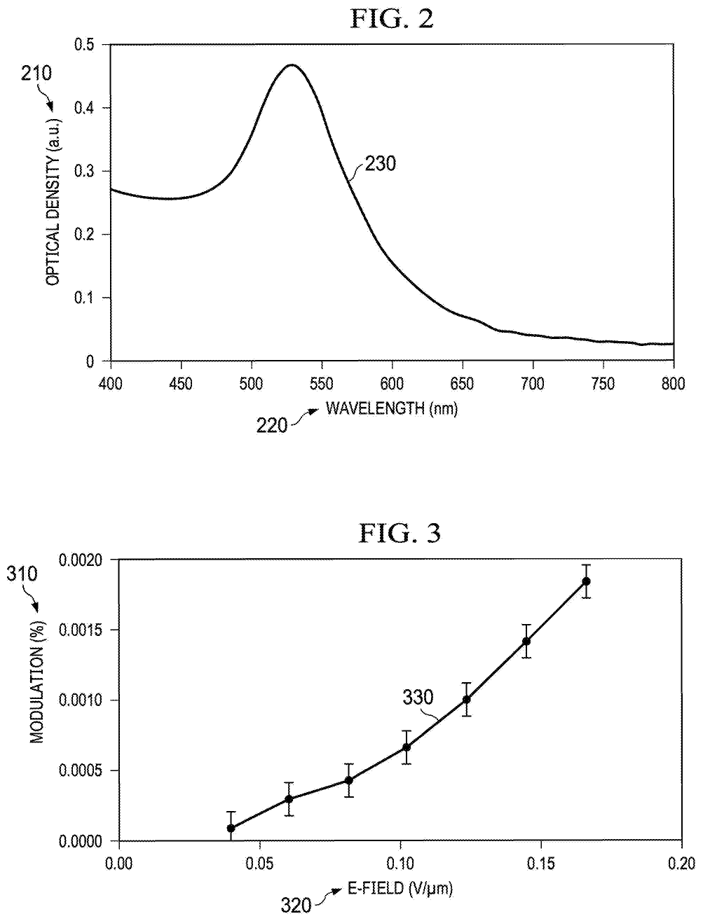

FIG. 2 is a graph of an example embodiment of the optical absorption spectrum (surface plasmon resonance) of 50 nm diameter gold nanoparticles in glass. The peak appears at the wavelength of about 534 nm.

FIG. 3 is a graph of an example embodiment of modulation data for different applied electric fields as recorded for 50 nm diameter gold nanoparticles in glass. Modulation is proportional to the square of the electric field. The Kerr coefficient is determined from the data.

### Example 1

Sample 1 of gold nanoparticles in glass (plates with dimensions: 4 cm×4 cm×3 mm) is examined. Optical absorption spectrum is recorded for light travelling through the thickness of the sample plate. The size of the gold nanoparticle is determined from the wavelength of the absorption peak (also called surface plasmon resonance) and the relative peak intensity. The absorption peak appears at shorter wavelengths and the relative intensity of the peak decreases for smaller nanoparticles. For sample 1, the peak is at 534 nm wavelength, which corresponds to a particle diameter of about 50 nm. Quadratic electro-optic measurements are made in these plates using the electric field-induced birefringence method discussed earlier. The beam at 633 nm from a He:Ne laser is passed through the long dimension (4 cm) of the plate. The Kerr coefficient as determined from the observed modulation signal is approximately 2.5×10⁻¹⁵ m/V².

### Example 2

Sample 2 of gold nanoparticles in glass (plates with dimensions: 4 cm×4 cm×3 mm) is examined. Optical absorption spectrum is recorded for light travelling through the thickness of the sample plate. The size of the gold nanoparticle is determined from the wavelength of the absorption peak (also called surface plasmon resonance) and the relative peak intensity. The absorption peak appears at shorter wavelengths and the relative intensity of the peak decreases for smaller nanoparticles. For sample 2, the peak is at 527 nm wavelength which corresponds to a particle diameter of about 25 nm. Quadratic electro-optic measurements are made in these plates using the electric field-induced birefringence method discussed earlier. The beam at 633 nm from a He:Ne laser is passed through the long dimension (4 cm) of the plate. The Kerr coefficient as determined from the observed modulation signal is approximately about 2.0×10⁻¹⁴ m/V² (eight times that of sample 1 in Example 1).

### Example 3

Sample 3 of gold nanoparticles in glass (plates with dimensions: 4 cm×4 cm×3 mm) is examined. Optical absorption spectrum is recorded for light travelling through the thickness of the sample-plate. The size of the gold nanoparticle is estimated from the wavelength of the absorption peak (also called surface plasmon resonance) and the relative peak intensity. The absorption peak appears at shorter wavelengths and the relative intensity of the peak decreases for smaller nanoparticles. For sample 3, the peak is at 520 nm wavelength which corresponds to a particle diameter of about 15 nm. Quadratic electro-optic measurements are made in these plates using the electric field-induced birefringence method discussed earlier. The beam at 633 nm from a He:Ne laser is passed through the long dimension (4 cm) of the plate. The Kerr coefficient as determined from the observed modulation signal is approximately 7.5×10⁻¹⁴ m/V² (thirty times that of sample 1 in Example 1).

According to the above results, the quadratic electro-optic effect/Kerr coefficient increases rapidly as particle diameter is decreased. The samples in examples 1-3 all had comparable optical density. The increase of the Kerr coefficient roughly goes as d⁻³, where d is the nanoparticle diameter. Therefore, for example, if the nanoparticle diameter is decreased to about 1 nm, the Kerr coefficient will be about 3×10⁻¹° m/V². Using such a large Kerr coefficient, electro-optic switching/modulation at high speed is possible at low drive voltages and short device lengths/dimensions. If optical fiber is fabricated using such glasses containing metal nanoparticles, practical devices for ultrafast switching/modulation can be built with a fiber length of less than one meter. In addition, novel Kerr cells may be fabricated using these metal nanoparticles-in-glass, providing lower costs compared to existing Pockels cells, for various electro-optic applications.

All the results discussed above may be extended to various metal nanoparticles within various other transparent dielectric media such as polymers/plastics and ceramics, other than glass. Quadratic electro-optic effect/Kerr coefficient has been measured in metal nanoparticles within a transparent dielectric medium. Kerr coefficients for gold nanoparticles in glass have been measured for different particle sizes. The Kerr coefficient increases significantly as particle-size is decreased. A particle diameter of about 50 nm of gold in glass has a Kerr coefficient of 2.5×10⁻¹⁵ m/V² at 633 nm wavelength. A particle diameter of about 25 nm of gold in glass has a Kerr coefficient of 2×10⁻¹⁴ m/V² at 633 nm wavelength. A particle diameter of about 15 nm of gold in glass has a Kerr coefficient of 7.5×10⁻¹⁴ m/V² at 633 nm wavelength. Electro-optic switches/modulators, Kerr cells, and other related electro-optic devices may be fabricated using metal nanoparticles in transparent dielectric media.

FIG. 4 provides flow chart 400 of a method of electro-optic applications with metal nanoparticles in dielectric media. In block 410, an alternating current field is applied to a sample comprising nanoparticles in a dielectric medium. In block 420, the Kerr coefficients of the sample are determined. In block 430, the sample is selected for electro-optic use based on the determined Kerr coefficients.

In summary, quadratic electro-optic effect/Kerr coefficients have been measured for the first time for metal nanoparticles within a transparent dielectric medium. In particular, gold nanoparticles in glass have been studied. The measurements have been made using field-induced birefringence method. The magnitudes of the Kerr coefficients for different sizes of gold nanoparticles in glass have been measured. The magnitude significantly increases for smaller sizes of nanoparticles. These results imply a broad range of applications of metal nanoparticles in dielectric media such as glass, in ultrafast (up to 100 GHz or more) electro-optic modulation/switching, low-cost Kerr cells and other uses in optoelectronics. The response time in these materials are known to be ultrafast (sub-picosecond). All the results discussed above may be extended to various metal nanoparticles within various other transparent dielectric media such as polymers/plastics and ceramics, besides the aforementioned glass. Electro-optical materials may be manufactured using the samples selected based on the determined Kerr coefficients.

Although the present disclosure has been described in detail, it should be understood that various changes, substitutions and alterations can be made thereto without departing from the spirit and scope of the disclosure as defined by the appended claims.

1. A method comprising:
applying an alternating current (AC) field to a dielectric medium comprising metal nanoparticles;
determining Kerr coefficients of the sample; and
selecting the dielectric medium for electro-optic use based on the determined Kerr coefficients.

2. The method of claim 1, wherein the AC field is applied to the dielectric medium with electrodes.

3. The method of claim 1, wherein the applied AC field is a radio frequency (RF) field.

4. The method of claim 1, wherein the Kerr coefficients are determined with quadratic electro-optic measurements.

5. The method of claim 3, wherein the quadratic electro-optic measurements are made using field induced birefringence.

6. The method of claim 4, wherein the birefringence is performed with a Helium Neon laser.

7. The method of claim 1, wherein the dielectric medium comprises glass.

8. The method of claim 1, wherein the nanoparticles comprise gold.

9. A material comprising:
a dielectric medium; and
metal nanoparticles embedded in the dielectric medium, the dielectric medium and metal nanoparticles selected to maximize Kerr coefficients of the material.

10. The material of claim 9, wherein the dielectric medium comprises glass.

11. The material of claim 9, wherein the nanoparticles comprise gold.

12. The material of claim 9, wherein selection of the dielectric medium and metal nanoparticles to maximize the Kerr coefficients of the material comprises determining the Kerr coefficients of the material by applying an alternating (AC) field to the material.

13. The material of claim 12, wherein the AC field is applied to the material with electrodes.

14. The material of claim 12, wherein the Kerr coefficients are determined with quadratic electro-optic measurements.

15. The material of claim 14, wherein the quadratic electro-optic measurements are made using field induced birefringence.

16. The material of claim 15, wherein the field induced birefringence measurement is performed with a Helium Neon laser.

17. The material of claim 12, wherein, the AC field is a radio frequency (RF) field.

18. A system for determining a Kerr coefficient of dielectric material with embedded metal nanoparticles comprising:
electrodes connected to the dielectric material with embedded metal nanoparticles;
an alternating current (AC) generator configured to apply an AC field to the dielectric material through the electrodes;
a laser configured to project a laser beam through the dielectric material; and
a measurement system configured to record the modulation of the laser light that has passed through the dielectric material and determine the Kerr coefficients, the Kerr coefficients determined based on observed modulations, applied electric field, and interaction path lengths within the material for given wavelengths of light.

19. The system of claim 18, the measurement system further comprising an analyzer, a lock-in amplifier, an oscilloscope, and a photodiode configured to record the modulation of the laser light and determine Kerr coefficients of the nanoparticles.

20. (canceled)

21. The system of claim 18, wherein the Kerr coefficients are determined with quadratic electro-optic measurements made using field induced birefringence with a Helium Neon laser.
